(19) United States
(12) Patent Application Publication
(10) Pub. No.: US 2019/0248068 A1
(43) Pub. Date: Aug. 15, 2019

(54) Method and Apparatus for Structuring a Surface for an Embossing Tool

(71) Applicant: AKK GmbH, Krefeld (DE)

(72) Inventor: Peer Kesper, Krefeld (DE)

(21) Appl. No.: 16/274,641

(22) Filed: Feb. 13, 2019

(30) Foreign Application Priority Data
Feb. 14, 2018 (EP) 18156686.0

(51) Int. Cl. B29C 64/165; B29C 59/02; B29C 64/393

(52) U.S. Cl. CPC B29C 64/165; B33Y 10/00; B29C 64/393; B29C 59/02

(57) ABSTRACT

The invention concerns a method of structuring a surface for an embossing tool, in which a tool blank with a surface is provided and in which an embossing structure is formed on the surface of the tool blank, which is intended for embossing a predetermined material. The task of proposing a method for structuring a surface for an embossing tool, in which a process-precise structuring, in particular with high resolution, is achieved and the method is simplified, is solved by printing structural material onto the tool blank by a 3D printing method in order to provide the embossing structure and the embossing structure comprises the structural material printed by the 3D printing method. The invention also concerns an embossing tool, an apparatus for structuring a surface for an embossing tool and a digital printing template.

### CROSS-REFERENCE TO RELATED APPLICATION

This application claims priority to European Patent Application No. 18156686.0 filed Feb. 14, 2018, the disclosure of which is hereby incorporated by reference in its entirety.

### BACKGROUND OF THE INVENTION

### Field of the Invention

The invention concerns a method of structuring a surface for an embossing tool in which a tool blank having a surface is provided and in which an embossing structure is formed on the surface of the tool blank which is intended for embossing a predetermined material. The invention also concerns an embossing tool for embossing a predetermined material, the embossing tool being structured, in particular, by means of the method in accordance with the invention, with an embossing structure formed on a surface which is intended for embossing a predetermined material. In addition, a device for structuring a surface for an embossing tool is revealed, in particular using the method according to the invention, the device comprising: receiving means for receiving a tool blank having a surface and structuring means for structuring the surface. The invention also concerns a digital artwork.

### Description of Related Art

The surfaces of embossing tools are structured with recesses to provide an embossing structure. The recesses must have a certain resolution for the embossed structure and also have a shape or rather depth profile that allows embossing on a given material. The recesses of embossing tools are usually complex in shape, i.e. the recesses have a profile or rather depth profile which changes with the distance to the original surface, e.g. tapers to ensure reliable embossing. For certain embossing processes, the embossing structure must also be provided with a sufficiently high resolution to ensure high quality of the embossed image on the material to be embossed.

A further requirement for the surface of an embossing tool is usually a sufficiently high hardness for embossing a given material, especially for embossing harder materials, in order to ensure a long service life of the embossing structure.

For structuring the surface of embossing tools various methods are known. On the one hand, etching methods can be used. Here, for example, a comprehensive stencil layer made of a photosensitive material is first applied to the surface. The stencil layer is selectively exposed, which changes the solubility of the exposed areas of the stencil layer. The stencil layer is structured by the subsequent removal of partial areas of the stencil layer with a solvent. An etching treatment of the surface is carried out with which the parts of the surface which are not covered by the stencil layer (or etch resist) are selectively etched. However, appropriate etching methods are often not suitable for high process speeds and are too imprecise with regard to the fine embossing structure required.

To increase the process speed, the surface can alternatively be machined, whereby the recesses are engraved mechanically by means of a graver. An electromechanical engraving can, for example, be carried out on the basis of a template, that is scanned at the same time, or computer-based. It is also known that an embossing structure of an embossing tool can be engraved directly into a surface by means of laser engraving. However, appropriate devices for electromechanical or laser engraving, however, are often complex and cost-intensive. In addition, high surface speeds may be present and associated with imbalances.

### SUMMARY OF THE INVENTION

Based on this state of the art, the invention is based on the task of proposing a process for structuring a surface for an embossing tool, whereby a process-precise structuring, in particular with high resolution, and a simplification of the process are achieved. Furthermore, an embossing tool and a device as well as a digital template for carrying out such a process shall be specified.

According to the first teaching of the invention, the above-mentioned task concerning a method for structuring a surface for an embossing tool is solved by printing structural material onto the tool blank with a 3D printing method in order to provide the embossing structure and the embossing structure comprises the structural material printed via the 3D printing method.

A tool blank can be formed in particular as a roll, roll shell or rather a sleeve and/or plate and have a surface which is suitable for applying an embossed structure. A tool blank can consist partly or completely of metal and/or metal compound and in particular have a metallic surface, for example a surface based on Fe, Cr, Ni, Cu and/or Zn or their compounds or also steel.

An embossing structure is formed on the surface of the tool blank, which is intended for embossing a given material. The embossing structure can, for example, reproduce a pattern of recesses or elevations, which is intended to produce a certain embossing image in the specified material. The embossing structure can in particular be considered as a negative of the intended embossing image in the given material, so that, for example, elevations in the embossing structure after embossing by the embossing tool create recesses in the given material. In particular, the embossed structure has a profile or depth profile which changes with the distance to the surface of the tool blank (i.e. to the original surface of the tool blank before structuring), for example tapers or widens. Preferably, the depth profile of elevations in the embossed structure widens towards the surface of the tool blank, so that the corresponding recesses taper in this direction.

By a 3D printing process structural material is printed onto the tool blank to provide the embossed structure. Consequently the embossed structure can be provided directly by a 3D printing process, which significantly simplifies structuring. Because the embossed structure comprises the structural material printed by 3D printing process, the flexibility and accuracy of the 3D printing process can be used to provide the embossed structure. Structural material can be selectively printed on the tool blank so that the printed material is already contoured during printing according to the intended embossing structure. In particular, the embossing structure can already receive the final contouring for later use in the embossing tool during the printing (possibly apart from a coating of the printed structural material described below).

That the embossing structure comprises the structural material printed by the 3D printing process, is to be understood in particular, in such a way that the printed structural material is partially or completely arranged between the surface of the tool blank and the outer surface of the embossing structure. The printed structural material may thus be partially or wholly disposed between the original surface of the tool blank prior to structuring and the outer surface of the embossed structure, whereby the outer surface of the embossed structure is intended for embossing the given material (or the outer surface of the embossed structure is intended for being brought into contact with the given material at an embossing). For example, by the 3D printing process elevations are formed on the surface or elevations are (directly) printed, which form an embossed structure. The elevations forming an embossed structure may at least partially comprise or consist of the structural material printed on the surface.

By printing of the structure material by a 3D printing process the embossed structure is thus provided or printed (if necessary directly). The printed structural material can thus at least partially form the negative of the intended embossed image in the given material, so that, for example, printed elevations of the embossed structure after embossing by the embossing tool produce recesses in the given material. Consequently further process steps can be omitted, like for example those steps when printing a stencil. If a stencil for chemical treatments of the surface such as an etching stencil is used the structuring of the surface still requires at least one chemical treatment step of the surface as well as a further step for removing the stencil. The corresponding steps can be omitted in the process according to the invention, since in particular the printed material remains on the surface of the embossing tool. Consequently, the structuring can be performed without the use of templates. In the case of etching methods for producing complex structures, the application of a stencil and a chemical treatment step often have to be repeated several times. By the present method, complex patterning can be simplified by printing structural material.

Printing the structural material by a 3D printing process, where the embossed structure comprises the structural material printed on by the 3D printing process, also means in particular that the embossed structure is provided by a formation of material on the tool blank. This is in contrast to the methods mentioned above, which are based on the removal of the material from the tool blank. Consequently, the inventive process also has the advantage that the embossed structure can be provided while saving material.

The 3D printing process for printing on the structural material can in particular be part of an additive manufacturing process (or also of a generative manufacturing process) or comprise additive/generative manufacturing. Structural material can be printed selectively on the surface. Various designs of the 3D printing process are imaginable. Structural material can be printed from the liquid, plastic, granular and/or powdery state. Examples are selective melting and/or sintering, especially electron beam melting, laser melting and/or laser sintering, binder jetting, fused deposition modeling, selective deposition welding or plating, wax deposition modeling, metal powder deposition, electron beam welding, stereolithography, selective exposure, liquid composite molding, laminated object modeling, 3D screen printing especially of metals and/or electrophoretic deposition.

In an arrangement of the process according to the first aspect, the structural material printed by the 3D printing process includes or consists of metal and/or metal compounds. Accordingly, an embossed structure can be provided by printing metal and/or metal compounds directly onto the surface and, in particular, by forming elevations by the printed metal and/or metal compounds. In particular, the embossing structure is given the final contouring for later use in the embossing tool immediately by printing, whereby metal and/or the metal compounds can exhibit high hardness and resistance for embossing of different materials even at high embossing pressure. Metals and/or metal compounds can also be resistant to high temperatures, so that certain hot stamping processes can also be carried out. The structural material may comprise Fe, Cr, Ni, Cu and/or Zn or their compounds. In particular, a metal or metal compound is printed as the structural material, which also forms the surface of the tool blank, so that uniform material properties of the embossed structure exist.

In a further implementation of the process according to the first aspect, the structural material printed by the 3D printing process comprises or consists of a wax, a UV curable ink or a combination thereof. With wax or a UV-curable ink, high resolutions or small print dots can be provided and thus high print quality is guaranteed. Especially a combination of wax and UV-curable ink has proven to be advantageous for structuring the surface. Such a combination can also have a sufficiently high temperature resistance for embossing processes. In particular, the structural material has a pasty consistency in order to guarantee high print quality. The use of wax and/or UV-curable ink means significant cost savings, especially compared to the use of metal and/or metal compounds, with a simultaneous increase in process speed and resolution.

In particular, the structural material is at least partially printed in a hot melt process. In a hot melt process, the structural material to be printed is heated and liquefied in a print head, for example in a temperature range from 60° C. to 120° C. Droplets of the liquefied stencil material are then brought onto the surface or jetted. The droplets cool during the flight to the surface and at the impact, so that the structural material solidifies on the surface of the gravure roller. A hot-melt process is carried out in particular with structural material comprising a combination of wax and UV-curable ink.

The printed structural material can also be cured during and/or after printing, for example by irradiation with UV light, thermal treatment, chemical treatment and/or cross-linking. The printed structural material may be subjected to chromium plating after printing.

In a further implementation of the process according to the first aspect, a coating of the structural material printed by the 3D printing process and/or of the surface of the tool blank is carried out. A coating can be used to adjust the mechanical and thermal properties of the outer surface of the embossed structure, which is intended for embossing the specified material, resulting from the structuring process. In particular, a coating has a higher hardness than the printed structural material, which improves the service life and embossing quality of the embossed structure. In particular, a coating is applied in combination with a printed structural material comprising a wax, a UV curable ink or a combination thereof. In particular, a combination of wax and UV-curable ink usually shows a hardness which can in principle be suitable for embossing various specified materials. By an additional coating the surface can be further refined. Coatings may in particular be formed by copper plating, nickel plating and/or chrome plating.

In one embodiment, the surface or structural material (e.g. comprising a plastic, a wax, a UV-curable ink or a combination thereof) is coated with 1 μm-10 μm Ni and/or Cu, preferably 2 μm to 3 μm Ni and/or Cu, and on the Ni layer and/or Cu layer a Cr layer and/or a hard nickel layer having a thickness of 1 μm to 20 μm is applied, preferably 4 μm to 6 μm. It is also possible to apply on the coating a further layer of the structural material (e.g. comprising a plastic, a wax, a UV-curable ink or a combination thereof) and in particular again to chromium-plate, so that in particularly a smooth surface or a high gloss level is achieved.

Also, different areas can be provided with different coatings. For example, dull and/or glossy areas are achieved. For example, the structural material is coated and then only some areas are coated with structural material once again.

A coating can be applied by electrochemical treatment, such as electroplating. In the case of metallic properties of the surface and the printed material, a direct electrochemical coating may be applied. Accordingly, structural materials with metallic properties can be selected for a planned electrochemical treatment, for example conductive polymers, composite materials or metallized plastics.

Where the surface and/or printed structural material has insulating properties, the surface and/or printed structural material may be metallized before or during electrochemical treatment. For example, a plastic is used as a structural material and metallized. Plastic electroplating can also be carried out here. Metallization includes, for example, an optional pickling step for roughening the surface of the structural material, activation (e.g. with metal nuclei such as Pd in a bath) and chemical metallization via a metallic layer (e.g. an electrically conductive coating of Cu and/or Ni). The surface can then be electroplated. Methods of electroless plating are also conceivable, especially for insulating structural materials.

Several layers can be applied, for example chromium plating and/or nickel plating can be preceded by the application of Cu, Zn and/or Ni to improve the adhesion of the chromium plated and/or nickel plated layer. In particular, after a Cu layer has been applied to an activated structural material, a Zn layer is applied and nickel plating is carried out, so that the outer surface of the embossed structure in particular is formed by the nickel plated layer.

In one implementation, the coating comprises Cr, Ni, Cu and/or Zn. In particular Cr or chrome plating produces a particularly hard and resistant surface for an embossed structure. However, Cr has disadvantages with regard to handling and environmental compatibility, so that Ni or nickel plating can be an advantageous alternative to Cr. Combinations of different metals or their compounds in single or multiple layers are also conceivable.

In a further implementation of the process according to the first aspect, the 3D printing process comprises a layer-by-layer printing of the structural material. A layer by layer printing enables a particularly process-safe and economical structuring of the surface over the structure material. The layer thickness of a single layer can be 1 μm to 20 μm, especially 5 μm to 10 μm. The number of intended layers (or the number of repetitions of the printing process for a single shift) can be up to 60, especially up to 100 or more. In the case of jetting, in particular a droplet volume of 2 pL up to about 10 pL, in particular at most 6 pL can be used in order to achieve a high resolution. During layered 3D printing, curing can take place; for example, each layer printed is cured before a next layer is printed. Curing can take place, for example, by irradiation with UV light, thermal treatment, chemical treatment and/or cross-linking.

The embossed structure can have a height of 10 μm to 1000 μm relative to the surface of the tool blank, in particular 30 μm to 200 μm or 40 μm to 100 μm. The height of the embossed structure is understood in particular as the maximum or average (arithmetic mean) extent of the embossed structure along the normal of the surface of the tool blank.

In a further implementation, the structural material printed by the 3D printing process is at least partially removed after printing and/or during printing. For example, the contour of the embossed structure can be further adapted by specifically removing the structural material. For example, the quality of the outer surface of the embossed structure, which is intended for embossing the given material, can also be adapted, particularly with regard to roughness, such as average roughness Rₐ and/or average roughness depth R_{z}. For example, smoothing or roughening can take place, whereby, for example, an outer surface of the embossed structure provided by the 3D printing process is improved with regard to suitability for embossing and/or coating. In particular, a higher gloss level is set. The removal of the structural material can be performed in particular by means of ablation such as laser ablation and/or chemical treatment. A mechanical treatment for the removal of structural material is also conceivable.

For example, a thermal treatment can also be carried out to remove structural material, whereby structural material in particular is softened or liquefied and removed. In particular, a structural material comprising wax can be used for this purpose. In a further implementation of the process, at least part of the areas of the embossed structure in which structural material was at least partially removed is filled with a supporting material. This is particularly advantageous if the structural material and/or the surface of the tool blank have been coated. For example, a structural material comprising wax is used and, in particular, a metallic coating is applied. The wax can then be at least partially removed by softening or melting so that the metallic coating remains and reproduces the contour of the embossed structure printed with the structural material. The areas of the embossed structure in which the structural material has been removed are filled with support material, which in particular is a harder and/or more temperature-resistant support material than the structural material. For example, metals, their compounds and/or polymer-based materials can be used as support materials.

According to the second teaching of the invention, the above mentioned task concerning an embossing tool for embossing a given material is solved by the fact that the embossing structure comprises structural material printed on the surface by a 3D printing process.

According to the above mentioned advantages and implementations for the process according to the first teaching, the embossing tool can have a process-accurate embossing structure with high resolution and be manufactured in a simple way. The printing of structural material also results in a different structure to the state of the art processes based on the removal of material from the surface of the tool blank.

In an implementation of the embossing tool, the embossing tool is designed as a roll, roll shell and/or plate. Corresponding molds can be used in a variety of embossing processes. A further implementation feature, in particular of rollers and roller shells, are embossing tools for a union process, in which two sister rollers (roll shells) with corresponding embossing structures are used in opposite directions for the embossing process.

In a further implementation of the embossing tool, the embossing tool is set up for hot embossing and/or cold embossing. Hot embossing, for example, can mean embossing with an embossing tool temperature and/or a temperature of the material to be embossed of more than 100° C. For example, cold embossing may mean embossing with an embossing tool temperature and/or temperature of the material to be embossed of less than 100° C., in particular less than 50° C. The embossing tool can have a temperature resistance at the corresponding embossing temperatures. The embossing temperature can be selected depending on the specified material. The embossing tool can also be intended for high-pressure processes and/or low-pressure processes.

Flat or ribbon-shaped materials, such as plates, foils and/or ribbons, can be used as the specified material to be embossed with the embossing tool or the embossing structure. Specified materials, which are intended in particular for hot stamping, can be wallpapers (for example comprising or in combination with heated PVC), (plastic-) foils, coated surfaces (for example with paper and/or acrylic lacquer), aluminum strips and aluminum foils, (artificial) leather and/or laminates (for example for floors). Specified materials, which are intended in particular for cold embossing, can be (synthetic) leather, paper, wallpaper, cellulose-based products (e.g. tissues, napkins, etc.) and coated products (e.g. products coated with acrylic varnish).

According to the third teaching of the invention, the above-mentioned task concerning a device for structuring a surface for an embossing tool is solved by the fact that the structuring means for a 3D printing process are arranged for printing structural material on the tool blank to form an embossed structure on the surface, the embossed structure comprising the structural material printed by the 3D printing process.

According to an implementation, the device also includes coating agents for coating the structural material printed by the 3D printing process and/or the surface of the tool blank, in particular by means of an electrochemical treatment. Coating agents may also include metallization agents.

According to the third teaching of the invention, the above-mentioned task is solved by means of a digital print template which contains information on how to structure a surface for an embossing tool in a process according to the first teaching.

For example, the method according to the first teaching can be performed on a device, in particular a device according to the third teaching, comprising at least one processor and at least one memory with computer program code, wherein the at least one memory and the computer program code are arranged to execute and/or control with the at least one processor at least one method according to the first teaching.

The digital artwork may contain information indicative, for example, of the printing of the structural material and, in particular, are used by the computer program code to execute at least one procedure according to the first teaching with at least one processor. The digital template can be stored on a storage medium. A computer-readable storage medium can, for example, be designed as a magnetic, electrical, electro-magnetic, optical and/or other storage medium. Such a computer-readable storage medium is preferably objective (i.e. “touchable”), for example it is designed as a data carrier device. Such a data carrier device is, for example, portable or permanently installed in a device. Examples of such a volume device are random access (RAM) volatile or non-volatile memories such as NOR flash memory or with sequential access such as NAND flash memory and/or read-only memory (ROM) or read-write memory. Computer-readable should be understood, for example, as meaning that the storage medium can be read and/or written by a computer or a data processing system, for example by a processor.

In particular, the prior or subsequent description of process steps in accordance with preferred forms of execution of a process shall also reveal appropriate means for performing the process steps in accordance with preferred forms of execution of a device. Likewise, by disclosing means of a device for carrying out a procedural step, the corresponding procedural step should also be disclosed.

### BRIEF DESCRIPTION OF THE DRAWINGS

Further advantageous exemplary forms of the invention can be found in the following detailed description of some exemplary forms of the present invention, in particular in connection with the figures.

FIGS. 1a-c schematic views of structured surfaces of state of the art embossing tools,

FIGS. 2a-d example of the execution of the invention method and embossing tool according to the invention,

FIG. 3 an example of the implementation of the device according to the invention, and

FIG. 4 different examples of a storage medium for a digital template according to the invention.

### DESCRIPTION OF THE INVENTION

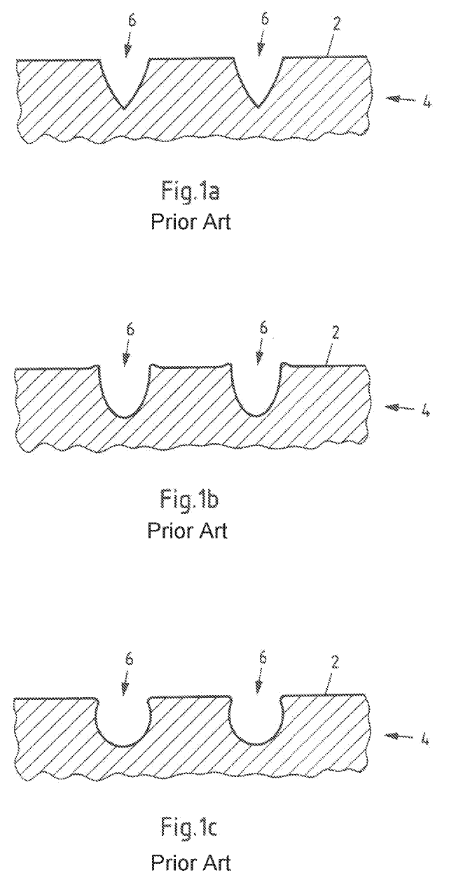

FIG. 1a-c first show schematic views of structured surfaces 2 of embossing tools 4, how these are generated by means of state-of-the-art structuring processes.

FIG. 1a shows a surface 2 with a structure introduced by mechanical engraving over a graver. The graver (not shown) is used to create recesses 6, the shape of which is typically determined by the shape of the graver and which, in particular, is tapered in depth as shown in FIG. 1a and, in particular, pointed.

FIG. 1b shows a surface 2 with a structure introduced by laser engraving or direct laser ablation. Laser ablation is used to remove material directly from surface 2 to create 6 recesses. The shape of the recesses 6 depends on the properties of the material of the surface under the influence of laser radiation during ablation and is particularly rounded in depth or rather in the depth profile as shown in FIG. 1b.

FIG. 1c shows a surface 2 with a structure introduced by etching methods. A stencil material is first applied to surface 2 (not shown) and, in particular, structured by exposure and partially removed. In the removed areas, the surface 2 is attacked with an etching solution so that recesses 6 are formed. The shape of the recesses 6 is determined by the etching attack on the material of surface 2 and is typically rounded in depth or rather the depth profile. Also, as indicated in FIG. 1c, undercuts of the template and the surface may occur.

The state of the art processes described here have in common that material is removed from the surface to be structured in order to provide an embossed structure.

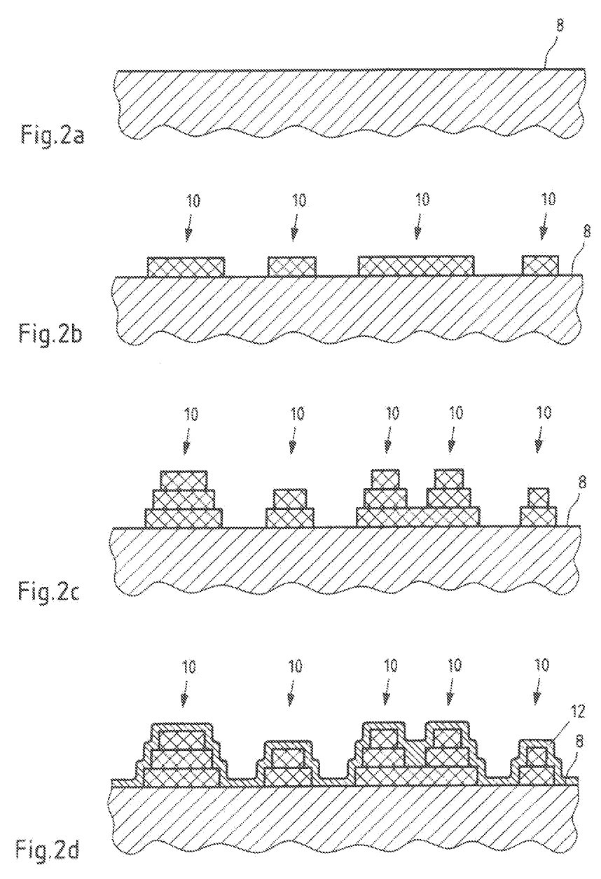

FIG. 2a-c show schematic views of how to structure a surface 8 for an embossing tool.

FIG. 2a first shows the surface 8 of a tool blank before structuring. The surface 8, for example, can be a metallic surface and in particular a surface based on Fe, Cr, Ni, Cu and/or Zn or their compounds or steel. In particular, the surface 8 is nickel-plated. The surface 8 is a surface of a tool blank and can be, for example, a surface of a plate, a roll or a roll shell.

An embossing structure is formed on the surface 8 of the tool blank, which is intended for embossing a given material. By a 3D printing process structural material is printed onto the tool blank to provide the embossed structure. The structural material is selectively applied to the surface. In this way elevations 10 are formed on the surface 8. In this example, the 3D printing process involves applying the structural material layer by layer, with the embossed structure comprising the structural material printed by the 3D printing process.

In FIG. 2b the surface 8 is shown after a first layer of structural material has been applied, the structural material forming elevations 10. The applied material may comprise or consist of metallic materials such as, in particular, steel, nickel, copper, zinc, chromium and their alloys and composite materials, with further metallic compounds with iron, nickel, copper, zinc and/or chromium also being possible. In the example shown, a combination of wax and UV-curable ink is applied by printing as a structural material for the elevations 10. The combination of wax and UV-curable ink has a pasty consistency, which means that the material can be printed reliably on the one hand and does not run on the surface on the other, so that the elevations 10 can be formed with a high resolution.

The structural material is applied in layers, so that in particular an embossed structure with a varying depth profile can be formed. The surface 8 of FIG. 2b is shown schematically in FIG. 2c after several layers of structural material have been applied and the elevations 10 are further developed. The elevations 10 show a height from 10 μm to 1000 μm, especially from 30 μm to 200 μm or 40 μm to 100 μm. The thickness of the individual layers applied is from 1 μm to 10 μm, in particular from 5 μm to 10 μm. In order to improve the accuracy of the embossed structure and to smooth the surface of the printed structural material, the structural material can optionally be partially removed again, in particular by means of ablation such as laser ablation.

It is conceivable that the surface 8 structured in this way with elevations 10 from FIG. 2c is already used as the embossing structure of an embossing tool insofar as the specified material to be embossed can be embossed by a corresponding surface, in particular with regard to the hardness of the printed structural material. In particular, such a use is conceivable if metallic structural materials are applied to the surface.

In the example shown in FIG. 2d, the exposed surface 8 of the tool blank and the structural material or rather the elevations 10 comprising the combination of wax and UV-curable ink are provided with a coating 12, whereby the coating 12 has a higher hardness than the printed structural material. This allows the embossing structure to be used for embossing harder materials and increases the service life of the embossing tool. The coating can also be smoothed.

To apply the coating 12 electrochemical methods can be used. If the surface 8 and/or the printed structural material or elevations 10 have electrically insulating properties, the surface 8 and/or the printed structural material or elevations 10 can be made accessible for electrochemical treatment via an activator. For example, the surface 8 and the printed structural material are exposed to a solution with an activator, especially in a bath with a solution comprising Pd. In particular, an electrically conductive coating of Cu and/or Ni is applied to facilitate an electrochemical treatment. An electrochemical treatment for the application of one or more coatings in the form of electroplating can be carried out, in particular chromium plating and/or nickel plating.

Several layers can be applied, e.g. chromium plating and/or nickel plating can be preceded by the application of Cu, Zn and/or Ni to improve the adhesion of the chromium plated and/or nickel plated layer. In particular, after a Cu layer has been applied to the activated surface 8 and/or elevations 10, a Zn layer is applied and nickel plating is carried out so that the outermost layer of the embossed structure is formed by the nickel plated layer. The embossed structure obtained in this way then essentially has a nickel-plated surface and can be used for embossing hard materials.

In another design, the surface or structural material is coated with 1 μm-10 μm Ni, preferably 2 μm to 3 μm Ni, and a Cr layer with a thickness of 1 μm to 20 μm, preferably 4 μm to 6 μm, is applied to the Ni layer. In this way the outer layer is formed of the chrome plating.

In an optional, not shown implementation, the structural material printed on surface 8 can be at least partially removed after application of the coating 12. This is particularly advantageous if the structural material printed on the surface does not have sufficient hardness and/or heat resistance for embossing, in particular hot embossing. For example, by the 3D printing process a structural material comprising a wax is applied which, after the coating has been applied, is softened or melted and removed by heating. A supporting material can be introduced into the resulting cavities under the coating 12, which, for example, has a higher hardness and/or heat resistance than wax.

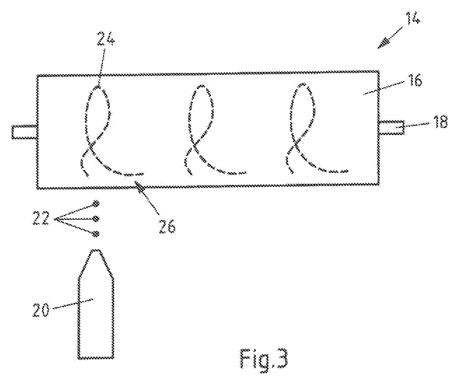

FIG. 3 shows a device 14 for structuring a surface for an embossing tool 16, whereby in particular the method according to the invention can be carried out via the device. The device comprises a receiving means 18 for receiving a tool blank with a surface and structuring means 20 for structuring the surface. The structuring agents 20 are set up for a 3D printing process for printing structural material onto the tool blank. For example, structuring means 20 include a 3D printing device with a print head that can selectively output 22 material to print 24 structural material. Hereby an embossed structure 26 can be formed on the surface, the embossed structure 26 comprising the structural material 24 printed by the 3D printing process.

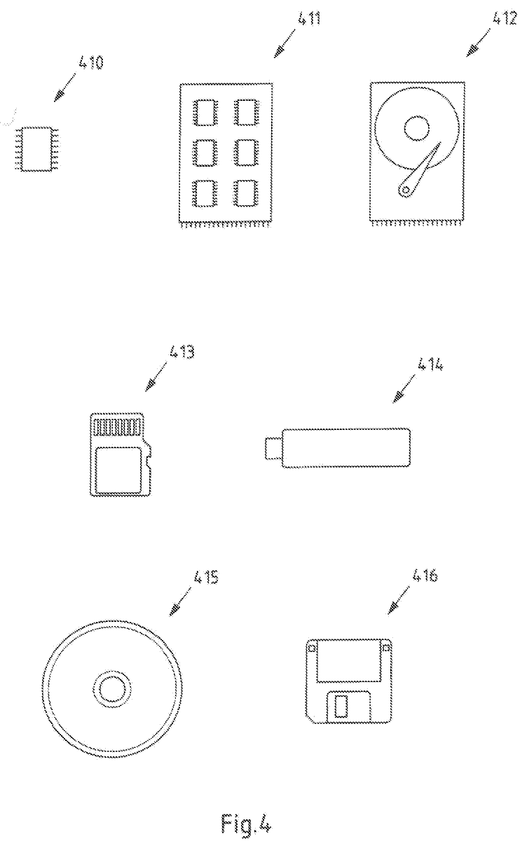

FIG. 4 finally shows different execution examples of storage media, on which an example of the execution of a digital template can be stored, which contains information on how to structure a surface for an embossing tool according to the invention. The storage medium may, for example, be a magnetic, electrical, optical and/or other storage medium. For example, the storage medium may be part of a processor, such as a (non-volatile or volatile) program memory of the processor, or part of it. Examples of a storage medium are a flash memory 410, an SSD hard disk 411, a magnetic hard disk 412, a memory card 413, a memory stick 414 (e.g. a USB stick), a CD-ROM or DVD 415 or a floppy disk 416.

1. A method for structuring a surface for an embossing tool, comprising:
providing a tool blank with a surface, and
forming an embossing structure on the surface of the tool blank for embossing a predetermined material,
wherein:
structural material is printed by a 3D printing process onto the tool blank to provide the embossing structure; and
the embossing structure comprises the structural material printed by the 3D printing process.

2. The method according to claim 1, wherein:
the structural material printed by the 3D printing process comprises metal, metal compounds, or a combination thereof.

3. The method according to claim 1, wherein:
the structural material printed by the 3D printing process comprises a wax, a UV-curable ink, or a combination thereof, and wherein the structural material has a pasty consistency.

4. The method according to claim 1, wherein:
a coating is applied to at least one of the structural material printed by the 3D printing process or the surface of the tool blank by an electrochemical treatment.

5. The method according to claim 4, wherein:
the coating comprises Cr, Ni, Cu Zn, or a combination thereof.

6. The method according to claim 1, wherein:
the 3D printing process comprises printing the structural material in layers.

7. The method according to claim 1, wherein:
the embossing structure has a height relative to the surface of the tool blank of 10 μm to 200 μm.

8. The method according to claim 1, wherein:
the structural material printed by the 3D printing process is at least partially removed after printing, during printing, or a combination thereof by ablation, thermal treatment, chemical treatment, or a combination thereof.

9. The method according to claim 8, wherein:
at least one part of regions of the embossing structure from which the structural material was at least partially removed is filled by a supporting material.

10. An embossing tool for embossing a predetermined material, comprising:
an embossing structure formed on a surface for embossing a predetermined material,
wherein:
the embossing structure comprises structural material printed on the surface by a 3D printing process.

11. The embossing tool according to claim 10, wherein:
the embossing tool is designed as a roll, roll shell, plate, or a combination thereof.

12. The embossing tool according to claim 10, wherein:
the embossing tool is adapted for at least one of hot embossing or cold embossing.

13. An apparatus for structuring a surface for an embossing tool, comprising:
a retaining device for holding a tool blank with a surface,
structuring means for structuring the surface,
wherein:
the structuring means are arranged for a 3D printing process for printing structural material onto the tool blank to form an embossing structure on the surface, and the embossing structure comprises the structural material printed by the 3D printing process.

14. The apparatus according to claim 13, further comprising coating means for coating at least one of the structural material printed by the 3D printing process or the surface of the tool blank by an electrochemical treatment.

15. A non-transitory computer-readable medium comprising a digital printing template to direct at least one processor to pattern a surface for an embossing tool by a method according to claim 1.

16. A non-transitory computer-readable medium comprising a digital printing template to direct at least one processor to pattern a surface for an embossing tool by a method according to claim 2.

17. A non-transitory computer-readable medium comprising a digital printing template to direct at least one processor to pattern a surface for an embossing tool by a method according to claim 3.

18. A non-transitory computer-readable medium comprising a digital printing template to direct at least one processor to pattern a surface for an embossing tool by a method according to claim 4.

19. A non-transitory computer-readable medium comprising a digital printing template to direct at least one processor to pattern a surface for an embossing tool by a method according to claim 6.

20. A non-transitory computer-readable medium comprising a digital printing template to direct at least one processor to pattern a surface for an embossing tool by a method according to claim 8.
